(19) United States
(12) Patent Application Publication
(10) Pub. No.: US 2026/0148308 A1
(43) Pub. Date: May 28, 2026

(54) VEHICLE SYSEM FOR GENERATING AND TRANSMITTING DRIVE CHARACTERISTIC PROBABILITY FOR A USAGE-BASED INSURANCE SERVER

(71) Applicant: Ford Global Technologies, LLC, Dearborn, MI (US)

(72) Inventors: Anuj Pal, St. Paul, MN (US); David Michael Herman, West Bloomfield, MI (US)

(21) Appl. No.: 18/959,022

(22) Filed: Nov. 25, 2024

(51) Int. Cl. G06Q 40/08; G07C 5/00; G07C 5/02

(52) U.S. Cl. CPC G06Q 40/08; G07C 5/008; G07C 5/02

(57) ABSTRACT

A vehicle system includes one or more computing devices configured to generate a drive characteristic probability distribution (CPD) using one or more aggregated vehicle signals, where the drive CPD associates one or more drive scenarios with one or more driver behaviors. The one or more computing devices is further configured to transmit, to a usage-based insurance (UBI) server, a drive CPD information including data indicative of a subsequent drive CPD in response to the subsequent drive CPD varying from a nominal CPD by a CPD threshold to cause an update of a UBI rate for a UBI policy associated with the vehicle.

### TECHNICAL FIELD

Aspects of the disclosure generally relate to transfer of data for drive characteristic probability distribution employed for vehicles utilizing usage-based insurance (UBI).

### BACKGROUND

Connected vehicles may send data to a cloud system. As the cloud system receives thousands of messages from millions of vehicles, this quantity of data may become large.

UBI is a type of vehicle insurance whereby the premium cost is dependent on the driving behavior of a driver. A UBI device may be connected to a vehicle network via a connector such as an on-board diagnostic II (OBD-II) port to collect vehicle operating data and send the data to a remote server for analysis. In other examples, a telematics control unit (TCU) of the vehicle may collect the vehicle operating data and send the data to the remote server for analysis.

### SUMMARY

In one form, the present disclosure is directed to a vehicle system including one or more computing devices. The one or more computing devices is configured to: generate a drive characteristic probability distribution (CPD) using one or more vehicle signals, where the drive CPD associates one or more drive scenarios with one or more driver behaviors. The computing devices are further configured to detect that a subsequent drive CPD varies from a nominal CPD by a CPD threshold, transmit, to a usage-based insurance (UBI) server, a drive CPD information including data indicative of the subsequent drive CPD in response to the subsequent drive CPD varying from the nominal, generate an updated nominal drive CPD using the one or more vehicle signals, and store the updated nominal drive CPD as the nominal drive CPD.

In another form, the present disclosure is directed to a non-transitory computer-readable medium comprising instructions for generation of a drive characteristic probability distribution (CPD) for a UBI that, when executed by one or more computing devices, cause the one or more computing devices to perform operations including to: generate a subsequent drive characteristic probability distribution (CPD) using one or more vehicle signals, where the drive CPD associates one or more drive scenarios with one or more driver behaviors. The instructions further cause the computing devices to detect that the subsequent drive CPD varies from a nominal CPD using a CPD threshold, transmit, to a usage-based insurance (UBI) server, a drive CPD information including data indicative of the subsequent drive CPD in response to the nominal drive CPD varying from the subsequent drive CPD, generate an updated nominal drive CPD using the one or more vehicle signals, and store the updated nominal drive CPD as the nominal drive CPD

In yet another form, the present disclosure is directed to a method for generating drive characteristic probability distribution (CPD) by a vehicle. The method includes aggregating a plurality of vehicle signals provided by one or more vehicle controllers to provide one or more aggregated vehicle signals, and generating one or more drive CPD using the one or more aggregated vehicle signals, where each drive CPD associates one or more drive scenarios with one or more driver behaviors. The method further includes determining a subsequent drive CPD varies from a nominal drive CPD in response to detecting at least one of a change point or a drift, transmitting, to a usage-based insurance (UBI) server, a drive CPD information including data indicative of the subsequent drive CPD in response to the subsequent drive CPD varying from the nominal drive CPD to cause an update of a UBI rate for a UBI policy associated with the vehicle, generating an updated nominal drive CPD using the one or more aggregated vehicle signals in response to the subsequent drive CPD varying from the nominal drive CPD, and store the updated nominal drive CPD as the nominal drive CPD.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example system for providing drive characteristic probability distribution for a UBI policy;

FIG. 2 is an example block diagram of a UBI module for a vehicle system; and

FIG. 3 illustrates an example process flow of the UBI module.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

UBI offers the potential to quote insurance products given varying driver behaviors. UBI quotes are based, in part, on signals captured by the vehicle. These signals are reflective of operation of the controllers of the vehicle, which accordingly is indicative of the driving behavior of the vehicle.

The present disclosure provides a system/method for a vehicle to generate a drive characteristic probability distribution (CPD) that may be used by a UBI server to set a UBI rate for an insurance policy associated with the vehicle. The drive CPD associates one or more drive scenarios with one or more driver behavior using probability distribution such as but not limited to normal distribution, Beta distribution, and/or Poisson distribution.

That is, the system of the present disclosure is configured to generate the drive CPD using one or more aggregated vehicle signals, which represents the driver behavior, and transmits, to the UBI server, a drive CPD information including data indicative of a subsequent drive CPD in response to a nominal drive CPD varying from the subsequent drive CPD by a CPD threshold. Instead of transmitting raw vehicle signals, the aggregated signals, or compound metrics for the UBI server for analysis, the vehicle transmit updated drive CPD information alleviating storage and computational load on the UBI server. In addition, by not continuously transmitting raw vehicle signals, the drive CPD information provides a level of anonymity or privacy to the driver of the vehicle 100 who has opted-in to the UBI policy and transmission of vehicle data.

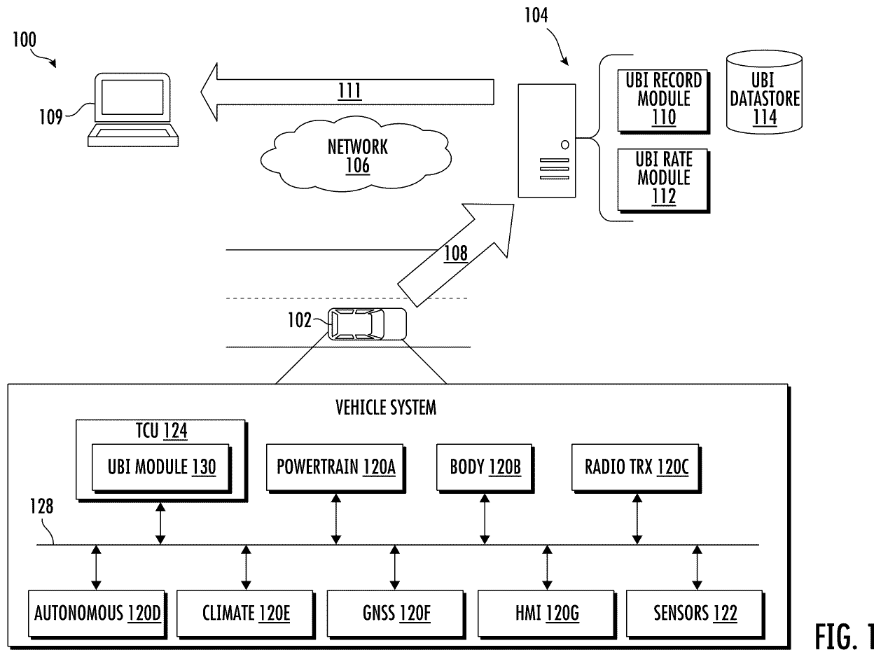

FIG. 1 illustrates an example system 100 for performing data collection and analysis for pricing of UBI. The system 100 includes one or more vehicles 102 that are enrolled in an UBI policy provided by an insurance provider. The vehicle 102 is configured to communicate with a UBI server 104 for the insurance provider via a communication network 106 to provide drive CPD information (illustrated by arrow 108). The drive CPD information includes data pertaining to a drive characteristic probability distribution that indicates the probability that the vehicle 102 may experience one or more defined drive scenarios (e.g., interference with objects, abrupt use of brakes, and/or sharp turns) based on the drive characteristics of the vehicle 102 (e.g., vehicle speed, positional relationship of the vehicle and surrounding objects, and/or miles driven).

The UBI server 104 is configured to communicate via the networks 106 with the vehicle 102 and other systems, such as computing device 109 accessing information in the UBI server 104 via a user interface, which may be a web based interface. In a non-limiting example, a UBI policy holder (e.g., a drive of the vehicle 102), may view the UBI policy rate for the vehicle 102 via the user interface (as illustrated by arrow 111).

The UBI server 104 is configured to define the UBI policy rate associated with the vehicle 102 using the drive CPD information, and includes a UBI record module 110, and a UBI rate module 112. The UBI record module 110 is configured to generate, update, and store UBI records in a UBI datastore 114. The UBI record provides information related to a policy holder of the UBI including, but not limited to, driver identification information (e.g., name, driver's license number, address), vehicle information (e.g., vehicle make/model, and/or VIN), UBI policy number, received drive CPD information, current UBI policy rate, and/or previous UBI policy rate.

The UBI rate module 112 is configured to define the UBI policy rate using the drive CPD information and a UBI rate model. Various modeling techniques may be used for the UBI rate model, such as but not limited to: one or more neural networks, random forests, and/or gradient boosted decision trees. In some aspects, defined drive scenarios can be classified as being positive or negative. For example, driver behaviors including wearing a seatbelt, checking blind spots, parking in a garage are associated with positive drive scenarios and driver behaviors including speeding, forward interference messages, or not wearing the seatbelt are associated with negative drive scenarios. The UBI rate model is configured to evaluate position factors associated with positive drive scenarios, negative factors associated with negative drive scenarios, or both positive and negative factors.

The vehicle 102 may be any various types of automobiles, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an internal combustion engine. As another possibility, the vehicle 102 may be a battery electric vehicle (BEV) powered by one or more electric motors. As a further possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians.

The vehicle 102 may include a plurality of controllers 120 (i.e., controllers 120A-120, collectively “controllers 120”) configured to perform and manage various vehicle 102 functions under the power of the vehicle battery and/or drivetrain. As depicted, the example vehicle controllers 120 are represented as discrete controllers 120 (i.e., controllers 120A through 120G). However, the vehicle controllers 120 may share physical hardware, firmware, and/or software, such that the functionality from multiple controllers 120 may be integrated into a single controller 120, and that the functionality of various such controllers 120 may be distributed across a plurality of controllers 120.

As some non-limiting vehicle controller 120 examples: a powertrain controller 120A may be configured to provide control of components of a vehicle powertrain that may include engine operating components (e.g., idle control components, fuel delivery components, emissions control components, etc.) and for monitoring status of such engine operating components (e.g., status of engine codes); a body controller 120B may be configured to manage various power control functions such as exterior lighting, interior lighting, keyless entry, remote start, and point of access status verification (e.g., closure status of the hood, doors and/or trunk of the vehicle 102); a radio transceiver controller 120C may be configured to communicate with key fobs, mobile devices, or other local vehicle 102 devices; an autonomous controller 120D may be configured to provide commands to control the powertrain, steering, or other aspects of the vehicle 102; a climate control management controller 120E may be configured to provide control of heating and cooling system components (e.g., compressor clutch, blower fan, temperature sensors, etc.); a global navigation satellite system (GNSS) controller 120F may be configured to provide vehicle location information; and a human-machine interface (HMI) controller 120G may be configured to receive user input via various buttons or other controls, as well as provide vehicle status information to a driver, such as fuel level information, engine operating temperature information, and current location of the vehicle 102.

The controllers 120 of the vehicle 102 may make use of various sensors 122 in order to receive information with respect to the surroundings of the vehicle 102. In a non-limiting example, the sensors 122 may include one or more of cameras (e.g., advanced driver-assistance system (ADAS) cameras), ultrasonic sensors, radar systems, and/or lidar systems.

The vehicle 102 further includes a telematics control unit (TCU) 124 configured to facilitate communication between the controllers 120 and with other devices of the system 100, such as the UBI server 104. For example, the TCU 124 may include or otherwise access a modem configured to facilitate communication over the communication network 106. The TCU 124 may, accordingly, be configured to communicate over various protocols, such as with the communication network 106 over a network protocol (such as Uu). The TCU 124 may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The TCU 124 may include various types of computing apparatus in support of performance of the functions of the TCU 124 described herein. In an example, the TCU 124 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, the processor receives instructions and/or data (e.g., from the storage medium) and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C #, Fortran, Pascal, Visual Basic, Python, Java Script, Perl, etc.

The vehicle 102 further includes one or more vehicle buses 128 that employ one or more methods to provide communication between the controllers 120, as well as between the TCU 124, the sensors 122, and the controllers 120. As some non-limiting examples, the vehicle bus 128 may include one or more of a vehicle controller area network (CAN), an Ethernet network, and a media-oriented system transfer (MOST) network.

The TCU 124 may be configured to facilitate the collection of vehicle signals from the vehicle controllers 120 connected to the one or more vehicle buses 128. While only a single vehicle bus 128 is illustrated, it should be noted that in many examples, multiple vehicle buses 128 are included, usually with a subset of the controllers 120 connected to each vehicle bus 128. Accordingly, to access a given controller 120, the TCU 124 may be configured to maintain a mapping of which vehicle buses 128 are connected to which controllers 120, and to access the corresponding vehicle bus 128 for a controller 120 when communication with that particular controller 120 is desired.

As used herein, vehicle signals may refer to various binary, multi-state, integer, float, and/or continuous parameters that may be generated or otherwise raised by the vehicle controller 120 and/or sensors 122. As some non-limiting examples, the vehicle signals may include one or more of: latitude, longitude, time, heading angle, speed, throttle position, brake status, steering angle, headlight status, wiper status, external temperature, turn signal status, ambient temperature or other weather conditions, alertness status, hands-off-wheel status, all-wheel drive (AWD) engaged status, front object detection, side object detection status, rear object detection status, etc.

The vehicle signals may be used to detect drive characteristics of the vehicle 102, which is further analyzed to determine a drive CPD. Specifically, the vehicle 102 includes a UBI module 130 that is configured to generate the drive CPD and transmits data indicative of the drive CPD to the UBI server 104 when appropriate. In one form, with access to the vehicle signals, the UBI module 130 is provided with the TCU 124. The UBI module 130 may be provided in the vehicle 102 in other suitable ways, including, but not limited to: provided with one of the controllers 120, and/or may be provided as a discrete controller separate from the TCU 124 and controllers 120.

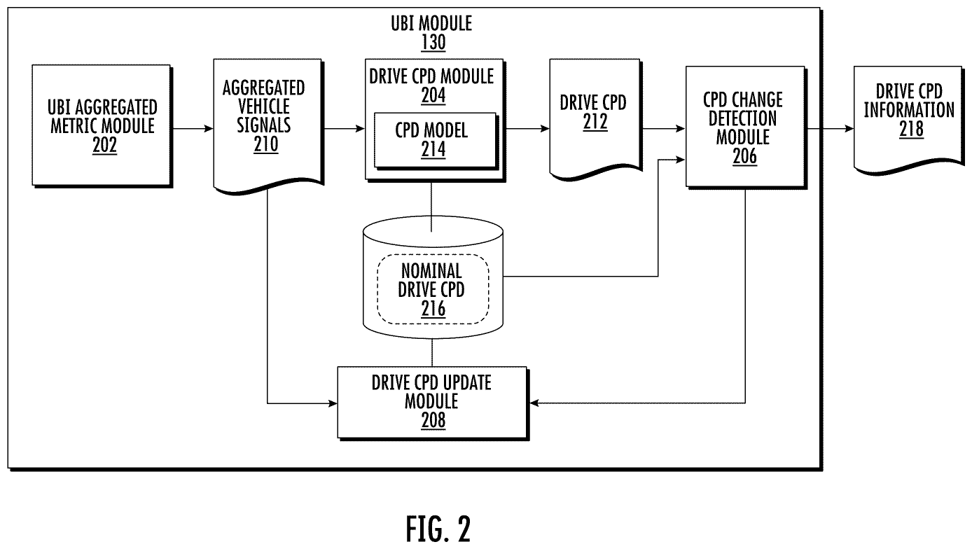

Referring to FIG. 2, in one form, the UBI module 130 is configured to include a UBI aggregated metric module 202, a drive characteristic probability distribution (CPD) module 204, a CPD change detection module 206, and a UBI drive CPD update module 208.

The UBI aggregated metric module 202 is configured to generate aggregated vehicle signals 210 using the vehicle signals received by the TCU 124. That is, the amount of vehicle signals present on the vehicle 102 may be large and difficult to transmit and store. In one form, the UBI aggregated metric module 202 includes aggregation functions that generate aggregated signals 210 based on a weighted collection of the vehicle signals. The aggregated signals 210 may include a subset of the individual signals retrieved from the controllers 120 and/or the sensors 122 over the vehicle buses 128, and weighted according to the aggregation function. In some cases, the aggregated signals 210 may further include contextual information, such as the current time, an identifier of the driver, location information from the GNSS controller 120F that may be used to augment the captured event information with locations of where the vehicle 102 was when the events occurred, etc.

In some aspects, the UBI aggregated metric module 202 generates the aggregated signals 210 in an event-based manner. For instance, the UBI aggregated metric module 202 generates the aggregated signals 210 when a condition of an aggregation function is satisfied by the vehicle 102 (e.g., by a sharp impulse in an accelerometer signal). In another example, the aggregated signals 210 can also be compiled from continuously sampled data from the vehicle buses 128 that is stored in the storage medium of the TCU 124. In yet another example, the aggregated signals 210 are defined using trip based normalized data (e.g., counting number of sharp accelerations per trip). The different example scenarios for calculating the aggregated signals may be combined or used separately.

The drive CPD module 204 is configured to generate a drive CPD 212 associates one or more drive scenarios with one or more driver behaviors using the aggregated vehicle signals 210. For example, with the aggregated vehicle signals 210 being representative of the drive behavior of the driver, the drive CPD 212 provides the probability one or more predefined drive scenarios may occur. In another example, drive CPD module 204 is configured to propagate the drive CPD 212 from the aggregated signals 210 to cover cost at the end of a time period (e.g., a mean probability of $500 USD +/−10 standard deviation).

In some aspects, the drive CPD module 204 is configured to include a CPD model 214 that generates the drive CPD 212. In a non-limiting example, the CPD model 214 is defined using data collected over-time on the drive behavior of multiple drivers, where the drive behavior may indicate braking pattern, speed pattern, mileage, or turning angle, among other driving tendencies. This data is aggregated and associated with one or more drive scenarios that may occur due to the drive behavior, such as, but not limited to: vehicle-object interference, activation of automatic braking, or a physical alteration of the vehicle when parked. Various techniques may be employed for defining the CPD model 214 including, but not limited to generalized linear models, machine learning classifiers, computer simulations, Bayesian analysis, statistical models, and/or actuarial models. The drive scenarios may include events that may occur when the vehicle 102 is in motion or when it is stopped/parked.

Furthermore, in addition to the drive CPD 212, the CPD model 214 is configured to generate a CPD uncertainty parameter with the drive CPD 212 to indicate a degree of confidence for the drive CPD 212. In a non-limiting example, the CPD model 214 generates the uncertainty parameter using Bayesian model. In another example, the uncertainty is provided as a quality of distribution fit (e.g., normal vs gaussian mixture). In yet another example, the uncertainty is provided as a quality of fit verses complexity such as number of metrics in distribution model.

The CPD change detection module 206 is configured to detect whether the drive CPD 212 varies from a nominal drive CPD 216 by a CPD threshold. The nominal drive CPD 216 provides a base drive CPD for the vehicle. In a non-limiting example, the nominal drive CPD 216 is based on the current rate/cost of the UBI policy associated with the vehicle 102, and an initial drive CPD for the nominal drive CPD 216 may be provided by the UBI server 104 based on an initial rate/cost of the UBI policy associated with the vehicle 102. In another example, the initial drive CPD for the nominal drive CPD 216 is determined by the drive CPD module 204. For instance, when the vehicle 102 enters the UBI policy and prior to detecting changes in the drive CPD, the drive CPD module 204 generates the drive CPD 212 and the CPD uncertainty parameter using the aggregated vehicle signals 210. When the CPD uncertainty parameter reaches a selected confidence level (e.g., the CPD uncertainty parameters is less than or equal to an uncertainty threshold), the drive CPD module 204 saves the determined drive CPD as the nominal drive CPD 216 (e.g., nominal drive CPD 216 stored in the storage medium of the TCU 124). Once determined, the nominal drive CPD 216 may be transmitted to the UBI server 104 with identification information associated with the drive and/or vehicle 102.

With the nominal drive CPD 216, the CPD change detection module 206 determines whether the drive CPD (e.g., a subsequent drive CPD provided after the nominal drive CPD 216) has changed from the nominal CPD 216 by the CPD threshold. In a non-limiting example, the CPD change detection module 206 is configured to determine that the drive CPD 212 varies by detecting at least one of a change point or a drift between the nominal drive CPD 216 and the subsequent drive CPD.

In a non-limiting example, the CPD change detection module 206 is configured to detect whether the drive CPD varies using at least one of: a Kalman filter that can track dynamic systems/distribution; a Bayesian change point detection model, a windowing model that divides data into windows (e.g., daily, weekly) and compares the distribution of each window to a reference window, where significant difference (e.g., difference greater than or equal to a CPD threshold) may indicate a shift or change point; a Page-Hinkley based model to detect changes in the mean of a time series that may occur over a longer period; and/or cumulative sum model that is configured to detect shifts in the mean of a time series when a baseline CPD is provided.

If the drive CPD 212 varies from the nominal drive CPD 216 by the CPD threshold (e.g., variation greater than or equal to the CPD threshold), the CPD change detection module 206 generates and transmits drive CPD information 218 including data indicative of the drive CPD (e.g., subsequent drive CPD) to the UBI server 104. With the drive CPD information, the UBI server 104 may evaluate drive CPD 212 and if applicable, update a UBI rate associated with the UBI policy for the vehicle 102 and/or update the drive CPD associated with the vehicle 102 and stored in the UBI record.

In some variations, the CPD change detection module 206 is configured to issue a notification indicative of updated information being provided to the UBI server for a user associated with the vehicle 102. In a non-limiting example, the notification includes audio/textual message provided via HMI 120G and/or an electronic mail message transmitted to an email address associated with the user (e.g., driver or customer associated with UBI policy) via the TCU 124.

The drive CPD update module 208 is configured to update the nominal drive CPD 216 employed for detecting the variation. In a non-limiting example, in response to the drive CPD varying from the nominal drive CPD, as indicated by the CPD change detection module 206, the drive CPD update module 208 stores an updated nominal drive CPD. The drive CPD update module 208 is configured generate the updated nominal drive CPD using the one or more aggregated vehicle signals 210. In some variations, the drive CPD update module 208 generates the updated nominal drive CPD using the aggregated vehicle signals 210 each time the drive CPD 212 is generated, and only saves the updated nominal drive CPD, as the nominal drive CPD 216, when the variation is detected by the CPD change detection module 206. In another variation, the drive CPD update module 208 uses the aggregated vehicle signals 210 associated with the drive CPD that varied from the nominal drive CPD 216 to generate the updated nominal drive CPD 216.

Various techniques may be employed to generate the updated nominal drive CPD such as but not limited to: a hypothesis testing model, an incremental learning model, or a Bayesian model. For example, the hypothesis testing model may include goodness-of-fit type of test (e.g., Kolmogorov-Smirnov test or the Anderson-Darling test) to assess how well the updated nominal drive CPD model fits the aggregated vehicle signals and/or a hypothesis type of test to detect if the changes are statistically significant (e.g., if a normal distribution is updated, a t-test may be used to compare the updated mean to the original mean). In another example, the incremental learning model may be used to gradually revise the update nominal drive CPD as new aggregated vehicle signals is received. In yet another example, the Bayesian models is used to incorporate new aggregated vehicle signals and update the parameters of the drive CPD distribution. In another example, the various techniques may be combined to improve robustness and accuracy.

With the UBI module 130, the vehicle enrolled in the UBI policy generates the drive CPD used by the UBI server 104 to set the UBI rate. This may eliminate or significantly reduce the amount of data being transmitted between the vehicle 102 and the server 104. In addition, the drive CPD may be transmitted when a variation is detected, further controlling the transmission of data. For instance, if the aggregated vehicles signals are detected after detection of an event, the drive CPD is transmitted to the server 104 if a variation is detected.

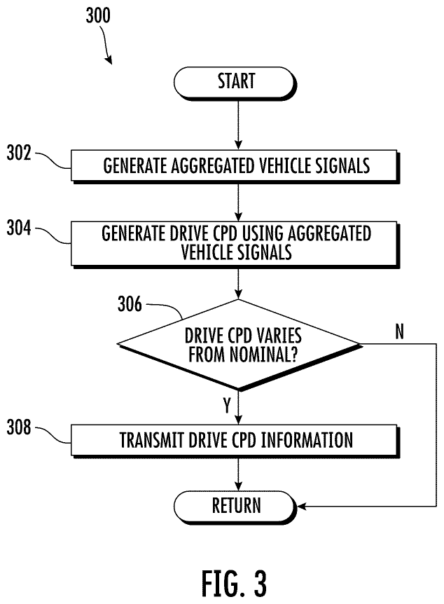

Referring to FIG. 3, an example UBI CPD analysis routine 300 performed by the UBI module 130 is provided. At operation 302, the UBI module 130 is configured to generate the aggregated vehicle signals 210 as described in above. For example, the aggregated vehicle signals are generated based on a detected event and/or may routinely generate the aggregated vehicles signals (e.g., after the vehicle 102 travels a selected distance).

At operation 304, with the nominal CPD saved, the UBI module 130 is configured to generate the drive CPD using the aggregated vehicle signals, as described above. The UBI module 130 may also calculate the CPD uncertainty parameter at operation 304.

At operation 306, the UBI module 130 is configured to determine if the drive CPD varies. For example, the UBI module 130 compares the drive CPD to the nominal CPD 216, and detects variation using one or more methods described herein.

If the drive CPD varies, the UBI module 130 transmits drive CPD information to the UBI server 104. For example, the drive CPD information include the drive CPD 212 and, if applicable the uncertainty parameter, along with contextual information (e.g., vehicle identification, user identification).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In a non-limiting example, the UBI Module 130, the TCU 124, the controllers 120, and/or the UBI server 104 may include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory or memory device is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses (e.g., the UBI module 120, the TCU 124, the controllers 120, and/or the UBI server 104) and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.” The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A vehicle system, comprising:
one or more computing devices provided in a vehicle and configured to:
store a nominal drive characteristic probability distribution (CPD),
aggregate one or more vehicle signals indicative of drive characteristics of a vehicle to define an aggregated vehicle signal, wherein the one or more vehicle signals includes at least one of a latitude, a longitude, a time, a heading angle, a speed, a throttle position, a brake status, a steering angle, a headlight status, a hands-off-wheel status, a front object detection, a side object detection status, or a rear object detection status,
generate a subsequent drive CPD using the aggregated vehicle signal, the subsequent drive CPD associating one or more drive scenarios with one or more driver behaviors to provide a probability that the one or more drive scenarios may occur, wherein the one or more drive behavior indicates at least one of a braking pattern, a speed pattern, a mileage, or a turning angle,
detect that the subsequent drive CPD varies from a nominal drive CPD by a CPD threshold,
transmit, to a usage-based insurance (UBI) server, a drive CPD information including data indicative of the subsequent drive CPD in response to the subsequent drive CPD varying from the nominal drive CPD by the CPD threshold, and
generate an updated nominal drive CPD using the aggregated vehicle signal, and store the updated nominal drive CPD as the nominal drive CPD.

2. The vehicle system of claim 1, wherein the one or more computing devices is configured to detect the subsequent drive CPD varying from the nominal drive CPD by detecting, at least one of, a change point or a drift between the nominal drive CPD and the subsequent drive CPD.

3. The vehicle system of claim 1, wherein the one or more computing devices is configured to detect the nominal drive CPD varying from the subsequent drive CPD using at least one of a Kalman filter, a Bayesian change point detection model, a windowing model, a Page-Hinkley based model, or cumulative sum model.

4. The vehicle system of claim 1, wherein, in response to the nominal drive CPD varying from the subsequent drive CPD, the one or more computing devices is configured to issue a notification indicative of updated information being provided to the UBI server.

5. The vehicle system of claim 1, wherein the updated nominal drive CPD is generated using at least one of, a hypothesis testing model, an incremental learning model, or a Bayesian model.

6. The vehicle system of claim 1, wherein the one or more computing devices is configured to generate an CPD uncertainty parameter associated with the subsequent drive CPD, wherein the drive CPD information further includes the CPD uncertainty.

7. The vehicle system of claim 6, wherein the one or more computing devices is configured to generate the CPD uncertainty using Bayesian-based model.

8. The vehicle system of claim 1, wherein the one or more computing devices is configured to define, prior to generating the subsequent drive CPD, the nominal drive CPD by calculating a drive CPD and a CPD uncertainty parameter that indicates a quality of a distribution of the drive CPD that is to be the nominal drive CPD, wherein the drive CPD is stored as the nominal drive CPD in response to the CPD uncertainty parameter being less than or equal to a CPD uncertainty threshold.

9. The vehicle system of claim 8, wherein the one or more computing devices is configured to transmit the nominal drive CPD to the UBI server in response to defining the nominal drive CPD.

10. A non-transitory computer-readable medium comprising instructions for generation of a drive characteristic probability distribution (CPD) for a user based insurance that, when executed by one or more computing devices in a vehicle, cause the one or more computing devices to perform operations including to:
store a nominal drive characteristic probability distribution (CPD),
aggregate one or more vehicle signals indicative of drive characteristics of a vehicle to define an aggregated vehicle signal, wherein the one or more vehicle signals includes at least one of a latitude, a longitude, a time, a heading angle, a speed, a throttle position, a brake status, a steering angle, a headlight status, a hands-off-wheel status, a front object detection, a side object detection status, or a rear object detection status,
generate a subsequent drive characteristic probability distribution (CPD) using the aggregated vehicle signal, the subsequent drive CPD associating one or more drive scenarios with one or more driver behaviors to provide a probability that the one or more drive scenarios may occur, wherein the one or more drive behavior indicates at least one of a braking pattern, a speed pattern, a mileage, or a turning angle,
detect that the subsequent drive CPD varies from a nominal drive CPD using a CPD threshold,
transmit, to a UBI server, a drive CPD information including data indicative of the subsequent drive CPD in response to the nominal drive CPD varying from the subsequent drive CPD,
generate an updated nominal drive CPD using the aggregated vehicle signal, and
store the updated nominal drive CPD as the nominal drive CPD.

11. The non-transitory computer-readable medium of claim 10, further comprising instructions that, when executed by the one or more computing devices, cause the one or more computing devices to perform operations including to detect the nominal drive CPD varying from the subsequent drive CPD by detecting, at least one of, a change point or a drift between the nominal drive CPD and the subsequent drive CPD.

12. The non-transitory computer-readable medium of claim 10, further comprising instructions that, when executed by the one or more computing devices, cause the one or more computing devices to perform operations including to detect the nominal drive CPD varying from the subsequent drive CPD using at least one of a Kalman filter, a Bayesian change point detection model, a windowing model, a Page-Hinkley based model, or cumulative sum model.

13. The non-transitory computer-readable medium of claim 10, further comprising instructions that, when executed by the one or more computing devices, cause the one or more computing devices to perform operations including issue a notification indicative of updated information being provided to the UBI server.

14. The non-transitory computer-readable medium of claim 10, further comprising instructions that, when executed by the one or more computing devices, cause the one or more computing devices to perform operations including to update the nominal drive CPD using at least one of, a hypothesis testing model, an incremental learning model, or a Bayesian model.

15. The non-transitory computer-readable medium of claim 10, further comprising instructions that, when executed by the one or more computing devices, cause the one or more computing devices to perform operations including to generate an CPD uncertainty parameter associated with the subsequent drive CPD, wherein the drive CPD information further includes the CPD uncertainty.

16. The non-transitory computer-readable medium of claim 15, further comprising instructions that, when executed by the one or more computing devices, cause the one or more computing devices to perform operations including to generate the CPD uncertainty using Bayesian-based model.

17. The non-transitory computer-readable medium of claim 10, further comprising instructions that, when executed by the one or more computing devices, cause the one or more computing devices to perform operations including to define prior to generating the subsequent drive CPD, the nominal drive CPD by calculating a drive CPD and a CPD uncertainty parameter that indicates a quality of a distribution of the drive CPD that is to be the nominal drive CPD, wherein the drive CPD is stored as the nominal drive CPD in response to the CPD uncertainty parameter being less than or equal to a CPD uncertainty threshold.

18. The non-transitory computer-readable medium of claim 17, further comprising instructions that, when executed by the one or more computing devices, cause the one or more computing devices to perform operations including to transmit the nominal drive CPD to the UBI server in response to defining the nominal drive CPD.

19. A method for providing drive characteristic probability distribution (CPD) by a vehicle, comprising:
aggregating a plurality of vehicle signals provided by one or more vehicle controllers to provide one or more aggregated vehicle signals, wherein the one or more vehicle signals includes at least one of a latitude, a longitude, a time, a heading angle, a speed, a throttle position, a brake status, a steering angle, a headlight status, a hands-off-wheel status, a front object detection, a side object detection status, or a rear object detection status;
generating one or more drive CPD using the one or more aggregated vehicle signals, each drive CPD associating one or more drive scenarios with one or more driver behaviors, wherein the one or more drive behavior indicates at least one of a braking pattern, a speed pattern, a mileage, or a turning angle;
determining a subsequent drive CPD varies from a nominal drive CPD in response to detecting at least one of a change point or a drift, wherein the one or more drive CPD includes the subsequent drive CPD;
transmitting, to a usage-based insurance (UBI) server, a drive CPD information including data indicative of the subsequent drive CPD in response to the subsequent drive CPD varying from the nominal drive CPD to cause an update of a UBI rate for a UBI policy associated with the vehicle;
generating an updated nominal drive CPD using the one or more aggregated vehicle signals in response to the subsequent drive CPD varying from the nominal drive CPD; and
storing the updated nominal drive CPD as the nominal drive CPD.

20. The method of claim 19, further comprising generating an CPD uncertainty parameter associated with the subsequent drive CPD, wherein the drive CPD information further includes the CPD uncertainty.
